(19) United States
(12) Patent Application Publication
(10) Pub. No.: US 2004/0260686 A1
(43) Pub. Date: Dec. 23, 2004

(54) System and method for providing a vendor showcase

(76) Inventors: James Woodroffe, Boston, MA (US); David Walsh, Cambridge, MA (US); Michael Bulat, Cambridge, MA (US)

Correspondence Address: Edwards & Angell, LLP, P. O. Box 55874, Boston, MA, 02205, US

(21) Appl. No.: 10/817,537

(22) Filed: Apr. 1, 2004

Related U.S. Application Data
(60) Provisional application No. 60/459,277, filed on Apr. 1, 2003.

(51) Int. Cl. G06F 17/30

(52) U.S. Cl. 707/3

(57) ABSTRACT

A server for facilitating a vendor showcase system, wherein the server communicates with clients via a distributed computing network, and wherein the server includes a memory storing an instruction set and vendor data related to a plurality of vendors. The server also includes a processor for running the instruction set, the processor being in communication with the memory and the distributed computing network. The processor is operative to (i) sort the vendor data based upon category, (ii) receive criteria related to a request for information, and (iii) provide a display of the vendor data for a pre-selected number of vendors based upon the criteria, wherein the display of the vendor data is presented in a flat manner. The processor may be further operative to compile return on investment statistics based upon user traffic and viewing at the display.

### CROSS-REFERENCE TO RELATED APPLICATION

This application claims priority to U.S. Provisional Patent Application No. 60/459,277, filed Apr. 1, 2003, which is incorporated herein by reference.

### BACKGROUND OF THE INVENTION

1. Field of the Invention

The subject disclosure relates to methods and systems for accessing vendor information via a distributed computing network, and more particularly to improved methods and systems for presenting vendor information and tracking the access to the same.

2. Background of the Related Art

Use of hard copy business-to-business and business-to-consumer directories has been widely used and well understood in the art since the widespread use of the telephone. However, the ability to place orders and access further information by using the telephone has suffered from limitations such as limited store hours, too few phone operators to handle heavy call demand and the like. Moreover, unless a business inquired about the source of the request, the effectiveness and other useful information was lost. In view of these and other shortcomings, the proliferation of the Internet has caused great optimism for the widespread dissemination of information, a large percentage of traditional brick-and-mortar transactions to become electronic commerce based, and detailed reporting on consumer demographics, habits and tendencies.

An example of a system attempting to utilize the Internet is illustrated in U.S. Pat. No. 6,519,572 to Riordan et al., incorporated herein by reference, is a method for collecting and processing marketing data. Riordan et al. discuss the shortcomings of surveys conducted by market research firms and preferred customer cards used to track customer purchases by retailers. Riordan et al. designed a system to track the transactions of a particular consumer to allow profiling the customer at a plurality of retailers. Riordan et al. do not recognize the need for the retailers to evaluate their marketing efforts let alone provide a mechanism for evaluating the same.

Another example is U.S. Pat. No. 6,604,681 to Burke et al., incorporated herein by reference, that discloses a shopping assistant system designed to provide consumers with information about a product of interest. The consumer is required to carry a portable device into the store and scan a product bar code to receive the desired information. Such a method is less than convenient and method specific hardware imposes an undesirable cost. Still another example is U.S. Pat. No. 6,574,606 to Bell et al. which is incorporated herein by reference. Bell et al. provide a method for cross-marketing products by providing hyperlinks to a related merchant's Web site from a vendor's Web site. The vendor Web site also uses artwork to identify the Web site as associated with the vendor and banner advertisements for presenting offers.

For another example, a Web site, superpages.com, has also attempted to utilize the Internet to provide an improved electronic directory. At the home page, a user may input a keyword, business name, city and/or state as a request to display possible resources, i.e. to generate a hit list. The number of matches displayed may also be selected with a default value being set at fifteen. The hit list consists of one or more links to further information, such as contact information. Upon requesting this additional information by selecting the link of interest, the user is finally presented with an address for the home Web site of the business. After surfing to the home Web site, the user may finally submit an inquiry or make a purchase if such service is available from the vendor. Typically, additional searching within the home Web site is required to drill down to product information and make a purchase of same.

In view of the above, a need exists for a system that quickly and easily provides consumers with access to information about a plurality of vendors as well as interaction with same. The improved system would also allow for analysis of its effectiveness.

### SUMMARY OF THE INVENTION

The present disclosure is directed to a server for facilitating a vendor showcase system, wherein the server communicates with clients via a distributed computing network, and wherein the server includes a memory storing an instruction set and vendor data related to a plurality of vendors. The server also includes a processor for running the instruction set, the processor being in communication with the memory and the distributed computing network. The processor is operative to (i) sort the vendor data based upon category, (ii) receive criteria related to a request for information, and (iii) provide a display of the vendor data for a pre-selected number of vendors based upon the criteria, wherein the display of the vendor data is presented in a flat manner. The processor may be further operative to compile return on investment statistics based upon user traffic and viewing at the display.

It is an object of the subject disclosure to showcase a plurality of vendors in a one level deep manner so that desired information is readily available to the user. It is another object of the disclosure to provide interaction between the vendor and user in a similarly flat manner. It is still another object of the disclosure to implement evaluation of the subject system and method.

It should be appreciated that the present invention can be implemented and utilized in numerous ways, including without limitation as a process, an apparatus, a system, a device, a method for applications now known and later developed or a computer readable medium. These and other unique features of the system disclosed herein will become more readily apparent from the following description and the accompanying drawings.

### BRIEF DESCRIPTION OF THE DRAWINGS

So that those having ordinary skill in the art to which the disclosed system appertains will more readily understand how to make and use the same, reference may be had to the following drawings.

FIG. 1 is a diagram showing an environment having a vendor showcase system in accordance with the subject disclosure.

FIG. 2 is a flow diagram of a process performed to create a vendor showcase system in accordance with the subject disclosure.

FIGS. 3A-E are exemplary Web pages as seen by a user in accordance with the vendor showcase system of FIG. 2.

FIG. 4 is another exemplary Web page as seen by a vendor in accordance with the vendor showcase system of FIG. 2.

### DETAILED DESCRIPTION OF PREFERRED EMBODIMENTS

The present invention overcomes many of the prior art problems associated with connecting on-line buyers and vendors. The advantages, and other features of the system disclosed herein, will become more readily apparent to those having ordinary skill in the art from the following detailed description of certain preferred embodiments taken in conjunction with the drawings which set forth representative embodiments of the present invention and wherein like reference numerals identify similar structural elements.

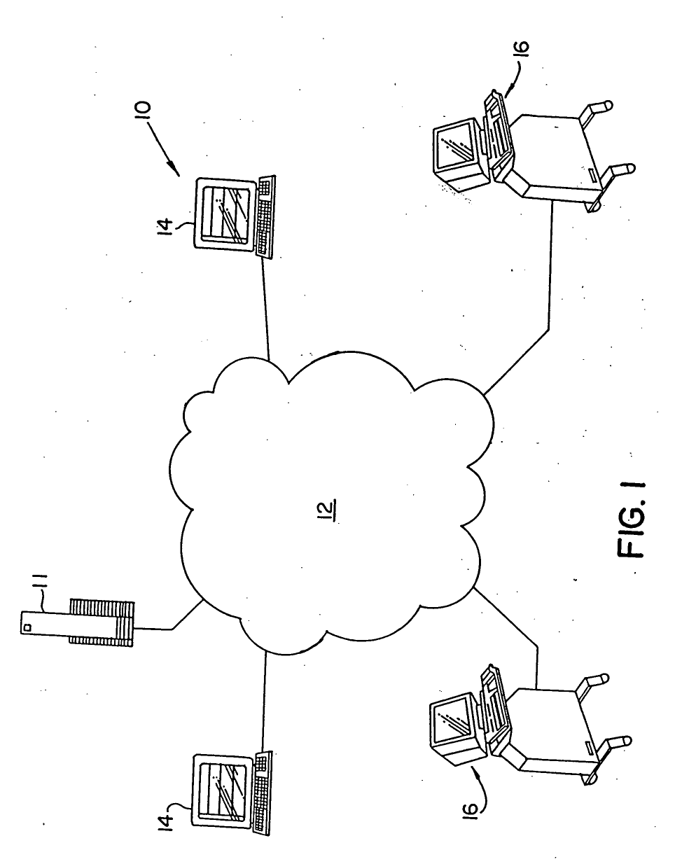

Referring now to the FIG. 1, there is shown in FIG. 1 a block diagram of an environment 10 with a vendor showcase system embodying and implementing the methodology of the present disclosure. The vendor showcase system connects on-line users (consumers, prospects and the like) with an on-line finite showcase of vendors. Preferably, input criteria are required for users to view vendor information. The vendor showcase system is user-interactive and self-contained so that users need not leave venture to another address within a distributed computing network to access a various information. The following discussion describes the structure of such an environment 10 but further discussion of the applications program and data modules that embody the methodology of the present invention is described elsewhere herein.

The environment 10 includes one or more servers 11 which communicate with a distributed computer network 12 via communication channels, whether wired or wireless, as is well known to those of ordinary skill in the pertinent art. In the preferred embodiment, the distributed computer network 12 is the Internet. For simplicity, one server 11 is shown. Server 11 hosts multiple Web sites and houses multiple databases necessary for the proper operation of the vendor showcase system in accordance with the subject invention.

The server 11 is any of a number of servers known to those skilled in the art that are intended to be operably connected to a network so as to operably link to a plurality of clients 14, 16 via the distributed computer network 12. As illustration, the server 11 typically includes a central processing unit including one or more microprocessors such as those manufactured by Intel or AMD, random access memory (RAM), mechanisms and structures for performing I/O operations, a storage medium such as a magnetic hard disk drive(s), and an operating system for execution on the central processing unit. The hard disk drive of the server may be used for storing data, client applications and the like utilized by client applications. The hard disk drive(s) of the server 11 also are typically provided for purposes of booting and storing the operating system, other applications or systems that are to be executed on the server, paging and swapping between the hard disk and the RAM.

It is envisioned that the server 11 can utilize multiple servers in cooperation to facilitate greater performance and stability of the subject invention by distributing memory and processing as is well known. U.S. Pat. No. 5,953,012 to Venghte et al. describes a method and system for connecting to, browsing and accessing computer network resources and is herein incorporated by reference in its entirety. Similarly, U.S. Pat. No. 5,708,780 to Levergood et al. describes an Internet server which controls and monitors access to network servers and is also herein incorporated by reference in its entirety.

Distributed computer network 12 may include any number of network systems well known to those skilled in the art. For example, distributed computer network 12 may be a combination of local area networks (LAN), wide area networks (WAN), or, as is well known. For the Internet, the preferred method of accessing information is the World Wide Web because navigation is intuitive and does not require technical knowledge.

The environment 10 also includes a plurality of computers or clients 14, 16 such as desktop computers, laptop computers, personal digital assistants, cellular telephones and the like. The clients 14, 16 allow users to access information on the server 11. For simplicity, only four clients 14, 16 are shown. The clients 14, 16 have displays and an input device(s) as would be appreciated by those of ordinary skill in the pertinent art. The display may be any of a number of devices known to those skilled in the art for displaying images responsive to outputs signals from the computers 14, 16. Such devices include but are not limited to cathode ray tubes (CRT), liquid crystal displays (LCDS), plasma screens and the like. Although a simplified diagram is illustrated in FIG. 1 such illustration shall not be construed as limiting the present invention to the illustrated embodiment. It should be recognized that the signals being outputted from the computer can originate from any of a number of devices including PCI or AGP video boards or cards mounted within the housing of the computers 14, 16 that are operably coupled to the microprocessors and the displays of the computers 14, 16.

Clients 14 typically provide consumer access to the environment 10 whereas clients 16 are associated with vendors and/or an entity that provides the vendor showcase system as a service although it will be recognized by those of ordinary skill in the art that the hardware of the clients 14, 16 would often be interchangeable. A plurality of consumers typically can share the same client 14 and cookie technology can be utilized to facilitate access to the environment 10 and, thereby, the vendor showcase system. A plurality of users can utilize the environment 10 simultaneously.

The clients 14, 16 are also prefereably equipped with an input device(s) as is known to those skilled in the art which can be used to provide input signals for control of applications programs and other programs such as the operating system being executed on the clients 14, 16. In illustrative embodiments, the input device preferably comprises a switch, a slide, a mouse, a track ball, a glide point or a joystick, a microphone or other such device (e.g., a keyboard having an integrally mounted glide point or mouse) by which a user such as a consumer can input control signals and other commands. Although the use of a keyboard as an input device is not described further herein, it is within the scope of the present invention for the input device to comprise any of a number of keyboards known to those skilled in the art, wherein the control signals or commands for implementing and interacting with the vendor showcase system and the applications program embodying such methodology can be implemented in the form of discrete commands via a keyboard.

The clients 14, 16 typically include a central processing unit including one or more micro-processors such as those manufactured by Intel or AMD, random access memory (RAM), mechanisms and structures for performing I/O operations (not shown), a storage medium such as a magnetic hard disk drive(s), a device for reading from and/or writing to removable computer readable media and an operating system for execution on the central processing unit. According to one embodiment, the hard disk drive of the clients 14, 16 is for purposes of booting and storing the operating system, other applications or systems that are to be executed on the computer, paging and swapping between the hard disk and the RAM and the like. In one embodiment, the application programs reside on the hard disk drive for performing the functions in accordance with the vendor showcase system. In another embodiment, the hard disk drive simply has a browser for accessing an application hosted within the distributed computing network 12. The clients 14, 16 can also utilize a removable computer readable medium such as a CD or DVD type of media that is inserted therein for reading and/or writing to the removable computer readable media.

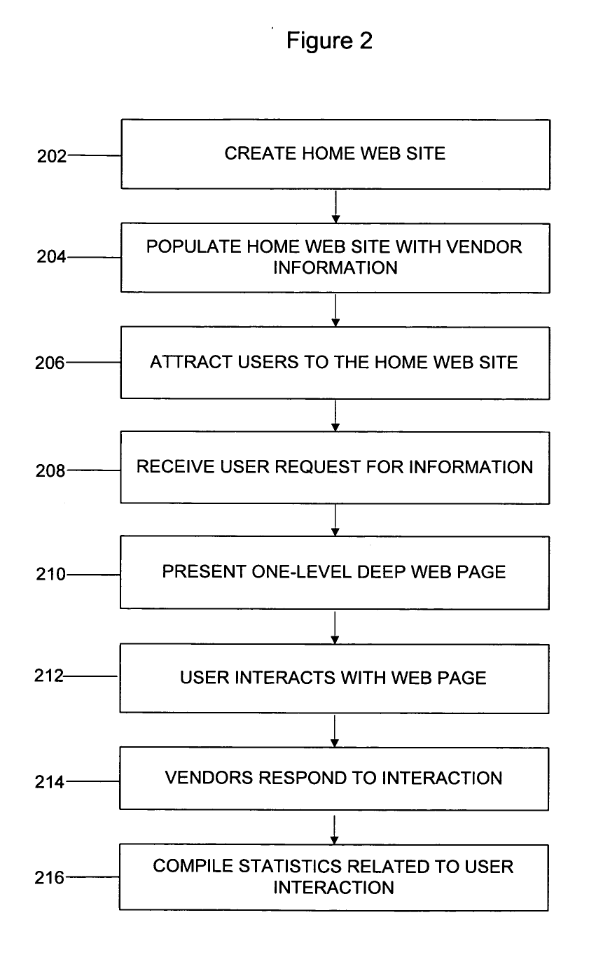

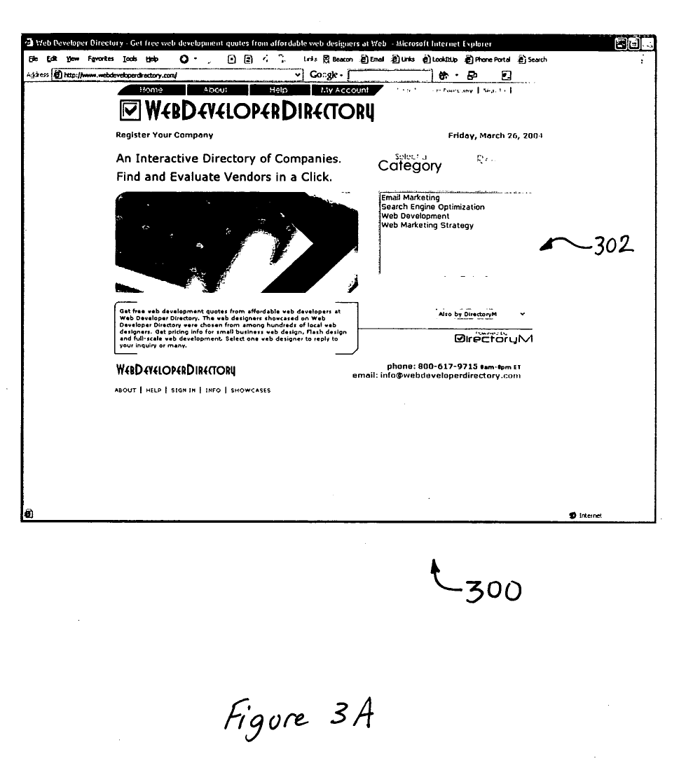

Referring now to FIG. 2, there is illustrated a flowchart 200 depicting a process for providing a vendor showcase system to Internet users in accordance with an embodiment of the present invention. At step 202, a host company (not shown) creates a home Web site to present vendor information to users in the form of a vendor showcase. Further, the company may maintain banner advertisements and links to related Web sites on the home Web site as a source of additional revenue. Preferably, the banner advertisements and links are associated with national and local vendors of complimentary goods and services and the company receives a further fee based upon referrals from same.

It is envisioned that the vendor showcase system provides for administration and security maintenance. Therefore, although each user (e.g., Internet surfers, vendor representatives and company representatives) has access to a client, each group's access is controlled. The interface specifies which aspects of the vendor showcase system can be accessed, and at what level in order to maintain compliance with technical electronic data interchange standards, legal confidentiality restraints, system integrity and the like. Such limitations of functionality are well known to those skilled in the art and therefore not further described herein.

At step 204, the host company demonstrates the home Web site to various vendors who would benefit from inclusion in the vendor showcases thereon in a sales effort to enlist the vendors as participants. When a vendor is enrolled in the vendor showcase system, the host company classifies the vendor within relevant industry categories and regions to form a record for the vendor. The plurality of vendor records are preferably stored in a relational database in server 11. Preferably, each vendor record also includes vendor contact information, narrative information and vendor account information.

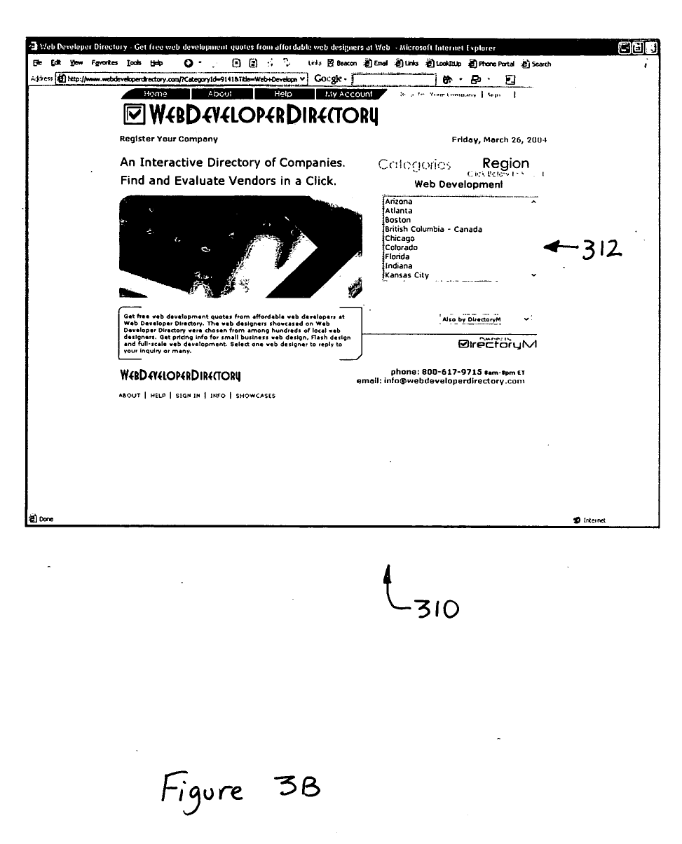

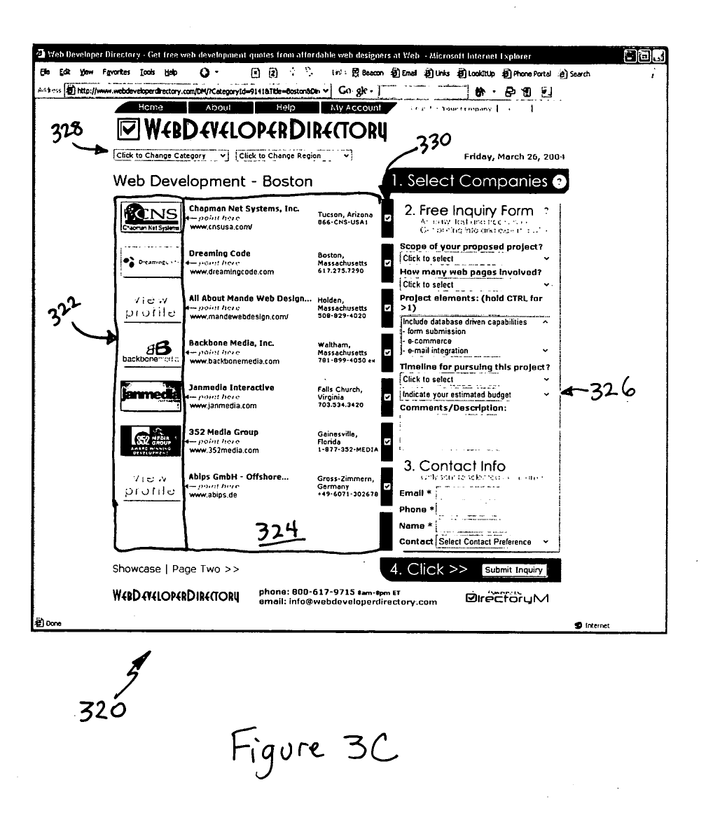

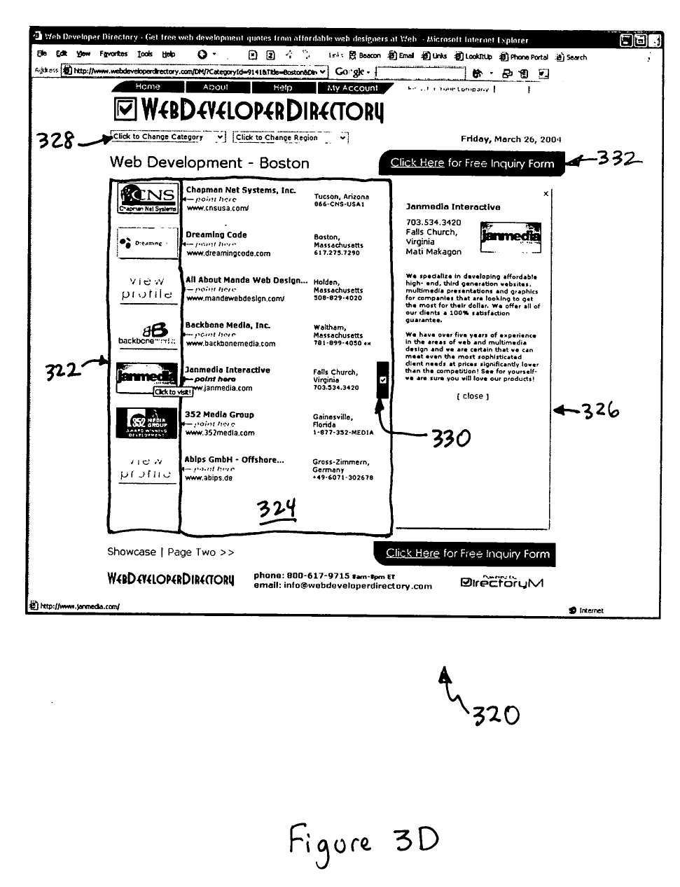

At step 206, the company and the enrolled vendors promote the home Web site to attract user traffic. Typical promotions may include identifying the home Web address on advertising and cooperation with a search engine that may direct a user to the home Web site based upon a search. Once a user is attracted to the home Web site, a Web page 300, as shown in FIG. 3A, may be presented. The Web page 300 includes an input area 302 for allowing a user to select a category from a list of categories. For example, without limitation, the categories may include audio-visual equipment, equipment rental, event planning, promotional products, search engine marketing, signage/graphics, trade show displays, Web site designers, wedding photographers, wedding planners and the like.

At step 208 of FIG. 2, the user navigates through the Web page 300 to access information. Upon selecting one of the categories shown in area 302, the user is presented with another Web page 310 as shown in FIG. 3B. The Web page 310 includes an input area 312 for allowing a user to select a region from a list of states. It is also envisioned that the regions may be presented by county, province, tri-state area and the like as would be appreciated by those of ordinary skill in the art upon review of the subject disclosure. Preferably, the user selects or “clicks” on the category, region or other criteria of interest only once to proceed.

Still referring to FIG. 2, at step 210, upon identification of category and and region of interest to the user, a vendor showcase Web page 320 is presented to the user. The vendor showcase Web page 320 includes a logo area 322, a contact information area 324 and a dynamic area 326. The Web page 320 also includes a reselection area 328 that allows a user to change category and/or region.

Upon the initial presentation of Web page 320, the dynamic area 326 includes an inquiry form. The inquiry form allows a user to request information from a particular vendor or a plurality of vendors at the same time. The requested information could be a pricing and/or availablity request and the like. A selection column 330 of Web page 320 indicates whether or not the iquiry form will be sent to the associated vendor. The contact information area 324 include static information associated, by row, with each vendor logo in the logo area 322. Preferably, the static information for each vendor includes the vendor name, a link to the vendor Web site, an address and telephone number for the vendor. The contact information area 324 also includes means for indicating that additional information is available by placing the cursor or other pointing indicia over the associated logo.

Referring back to FIG. 2, at step 212, the user interacts with the Web page 320. When a user positions the cursor over a logo in the logo area 322, the dynamic area 326 is modified to reflect detailed information related to the vendor associated with the logo as shown in FIG. 3D. The detailed information preferably includes any contact information and a narrative indicative of the vendors specialty. In another embodiment, the detailed information of dynamic area 326 includes examples of the vendors work. At this time, the checkbox in selection column 330 can be activated or deactivated to determine whether or not the inquiry form will go to the associated vendor. In the logo area 322, a pre-selected number of vendor logos within the category and region of interest are presented. Preferably, the vendor showcase Web page 320 includes eight vendor logos. In a preferred embodiment, when an excess of vendors who satisfy the region and category requirements are populated in the relational database, a rotation of logos displayed occurs so that each vendor is exposed to the same number of users over time.

Referring to FIGS. 3D and 3E, in dynamic area 326, after selecting the vendors of interest in column 330, the user can return to the inquiry form by selecting the indicator 320 at the top of dynamic area 326. In the inquiry form, the user can utilize pulldown menus, dialog boxes and like features to provide the details of an inquiry to the selected vendors. When the inquiry form is complete, the user can submit the inquiry form and the process proceeds to step 214. Upon submission, the information of the inquiry form is sent directly to the vendor via electronic mail. In view of the above, it will be appreciated that the Web page 320 is intentionally one-level deep, i.e. once the users is presented with Web page 320, the users do not need to visit additional Web pages to achieve interactive fulfillment.

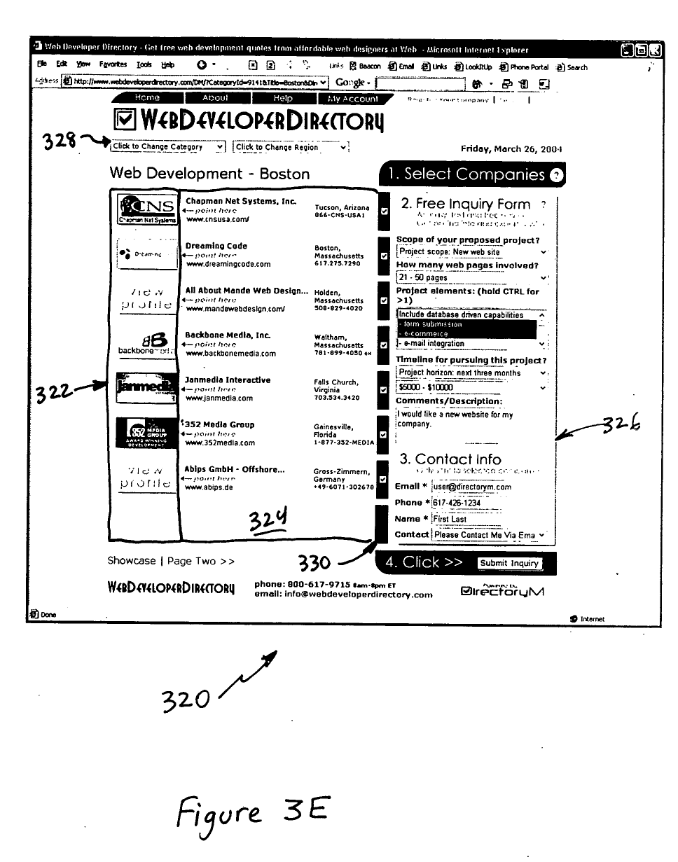

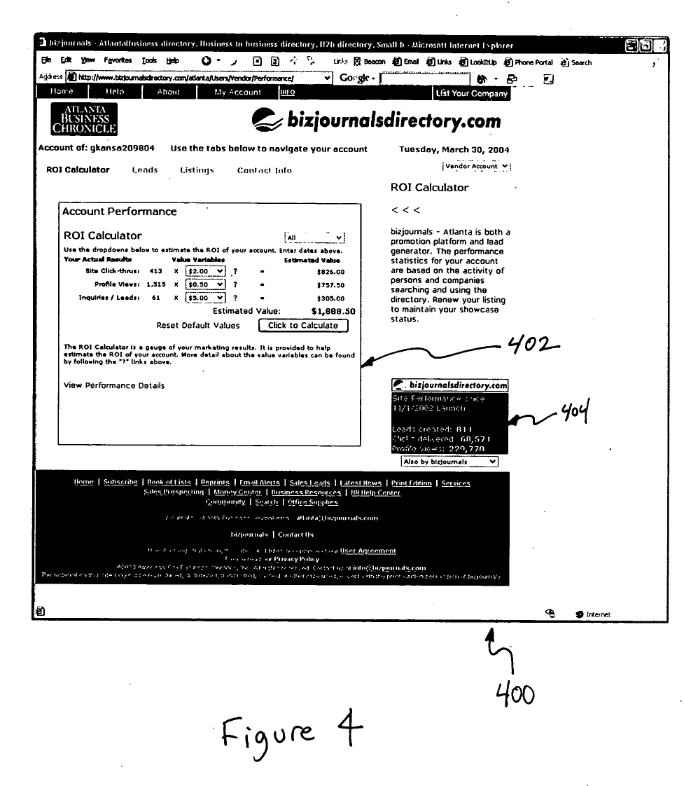

Referring again to FIG. 2, at step 214, the vendor can respond to the user inquiry. In a preferred embodiment, the vendor has the choice of responding by telephone or electronic mail. In one embodiment, the electronic mail is registered at the home Web site to encourage the user to revisit in order to review the vendor response. At step 216, the vendor showcase system compiles statistics related to user interaction as shown in the exemplary Web page 400 of FIG. 4. Preferably, the compiled statistics are detailed vendor by vendor. Each vendor would have a username and password so that access may be restricted. An account performance section 402 of Web page 400 provides summaries of the compiled statistics so that the vendor may review the return on investment associated with enrollment in the vendor showcase system. The vendor showcase system tabulates various parameters such as home Web site click-thrus, vendor profile views and inquiries (e.g., receipts of inquiry forms from users). Each type of parameter may be assigned a dollar value so that a quantitative total may be calculated. The vendor can utilize a pull-down menu to adjust the dollar value associated with each parameter to properly reflect the actual value for the category.

In another embodiment, the time period for the account performance can be varied such as in area 404 of Web page 400. The account performance statistics in section 402 are preferably updated on a periodic basis such as nightly, weekly, bi-weekly, monthly and the like. It is understood that the vendor interaction with the vendor showcase system is by having a representative of the vendor access the vendor showcase system via vendor client 16 in environment 10 of FIG. 1. Such vendor representative is also allowed administrative access to perform such tasks as removing and adding features, customizing the profile presented in area 326 of Web page 320, administering access by other vendor representative, generating reports related to return on investment and the like.

In another embodiment, the vendor showcase system is offered as an Internet hosted application where each vendor sponsors customized Web pages in accordance with the subject disclosure. Such vendors are hereinafter referred to as affiliates. The affiliates can monitor the traffic as outlined above as a means of acquiring feedback on the design of the Web pages. As a result, the original Web pages can be modified or updated to maintain the Web pages in the most desirable form. Preferably, the affiliates gain synergy from the vendor showcase system in combination with a traditional bricks and mortar business. In an alternative embodiment, the host company bundles a plurality of advertising mediums together with the vendor showcase system such as including print, radio and television advertisements.

In one embodiment, the vendor showcase system is a desktop computer application that is either downloaded or provided on a compact disk. In another embodiment, the vendor showcase system is provided in booklet form for reproduction on a copy machine, completion and traditional mailing.

It will be appreciated by those of ordinary skill in the pertinent art that the functions of several elements may, in alternative embodiments, be carried out by fewer, or a single element. Similarly, in some embodiments, any functional element may perform fewer, or different, operations than those described with respect to the illustrated embodiment. Also, functional elements (e.g., modules, databases, interfaces, computers, servers and the like) described as distinct for purposes of illustration may be incorporated within other functional elements in a particular implementation.

While the invention has been described with respect to preferred embodiments, those skilled in the art will readily appreciate that various changes and/or modifications can be made to the invention without departing from the spirit or scope of the invention as defined by the appended claims.

What is claimed is:

1. A server for facilitating a vendor showcase system, wherein the server communicates with clients via a distributed computing network, and wherein the server comprises:
(a) a memory storing an instruction set and vendor data related to a plurality of vendors; and
(b) a processor for running the instruction set, the processor being in communication with the memory and the distributed computing network, wherein the processor is operative to:
(i) sort the vendor data based upon category;
(ii) receive criteria related to a request for information; and
(iii) provide a display of the vendor data for a pre-selected number of vendors based upon the criteria, wherein the display of the vendor data is presented in a flat manner.

2. A server as recited in claim 1, wherein the criteria are regional and category data.

3. A server as recited in claim 1, wherein the vendor data includes regional, category, and logo data.

4. A server as recited in claim 3, further comprising an inquiry form within the display.

5. A server as recited in claim 4, wherein the processor is further operative to morph the inquiry form when a cursor is placed on a logo such that information associated with the logo is presented where the inquiry form used to be.

6. A server for facilitating a vendor showcase system, wherein the server communicates with clients via a distributed computing network, and wherein the server comprises:
(a) a memory storing an instruction set and vendor data related to a plurality of vendors; and
(b) a processor for running the instruction set, the processor being in communication with the memory and the distributed computing network, wherein the processor is operative to:
(i) sort the vendor data based upon category;
(ii) receive criteria related to a request for information;
(iii) provide a display to a plurality of users associated with clients, the display being of the vendor data for a pre-selected number of vendors based upon the criteria;
(iv) track usage of the display by the users; and
(v) compile return on investment statistics based upon the tracking of the usage.

7. A server as recited in claim 6, wherein the investment statistics include a total dollar value based upon a user-selected valuation of each usage event.

8. A vendor showcase system comprising:
(a) first means for sorting vendor data based upon category in a relational database;
(b) second means for receiving criteria related to a request for information; and
(c) third means for providing a display of the vendor data for a pre-selected number of vendors based upon the criteria, wherein the display of the vendor data is presented in a flat manner.

9. A vendor showcase system as recited in claim 8, wherein the first, second and third means are program instructions stored in memory.
